(19) United States
(12) Patent Application Publication
(10) Pub. No.: US 2025/0182670 A1
(43) Pub. Date: Jun. 5, 2025

(54) DISPLAY DRIVING SYSTEM AND DRIVING METHOD THEREOF, DISPLAY DEVICE

(71) Applicant: TCL CHINA STAR OPTOELECTRONICS TECHNOLOGY CO., LTD., Shenzhen (CN)

(72) Inventors: Weifeng CHEN, Shenzhen (CN); Qingsheng LAN, Shenzhen (CN)

(21) Appl. No.: 18/399,514

(22) Filed: Dec. 28, 2023

(30) Foreign Application Priority Data
Nov. 30, 2023 (CN) 202311637439.0

(51) Int. Cl. G09G 3/20

(52) U.S. Cl. CPC G09G 3/2096; G09G 2310/0275; G09G 2310/061; G09G 2330/021

(57) ABSTRACT

A display driving system applied to a display panel. The display driving system includes a source driver and a power managing circuit. The source driver includes a recognition module configured to recognize an instruction, and a power saving control module, electrically connected to the recognition module for generating a plurality of power saving control signals based on the instruction. The power managing circuit is electrically connected to the source driver. The power managing circuit includes an electrical signal generation module, electrically connected to the power saving control module for reducing a magnitude of the generated electrical signal based on the power saving control signal.

### CROSS REFERENCE TO RELATED APPLICATION

This application claims priority to Chinese Application No. 202311637439.0, filed on Nov. 30, 2023. The entire disclosures of the above applications are incorporated herein by reference.

### FIELD OF THE INVENTION

The present disclosure relates to the field of display technology, more particularly, to a display driving system, a driving method thereof, and a display device.

### BACKGROUND

With the further improvement of energy efficiency standards, energy consumption indicators have also been improved.

In the panel industry, the overall power consumption target also needs to be reduced, so low-power technology and algorithms will be hardware requirements for the next generation of display driving systems. In response to energy consumption standards, it is necessary to optimize the power consumption of display driving systems and enhance the competitiveness of panel products.

### SUMMARY

The purpose of the present disclosure is to provide a display driving system, its driving method, and a display device to reduce the power consumption of existing display driving systems and display panels containing display driving systems.

The present disclosure provides a display driving system applied to a display panel. The display driving system includes a source driver and a power managing circuit. The source driver includes a recognition module configured to recognize an instruction, and a power saving control module, electrically connected to the recognition module for generating a plurality of power saving control signals based on the instruction. The power managing circuit is electrically connected to the source driver. The power managing circuit includes an electrical signal generation module, electrically connected to the power saving control module for reducing a magnitude of the generated electrical signal based on the power saving control signal.

In one embodiment of the present disclosure, the power saving control module comprises a plurality of switch elements connected in parallel. A plurality of input terminals of the plurality of switch elements are electrically connected and loaded with working voltage, and a plurality of output terminals of the plurality of switch elements are connected to the electrical signal generation module. The source driver further comprises a logic module, electrically connected to a plurality of control terminals of the recognition module and the switching elements, configured to turn on and turn off the plurality of switching elements according to the instruction, in order to control the power saving control module to generate the power saving control signal.

In another embodiment of the present disclosure, the display driving system is configured to control the display panel to operate in a scanning stage and to control the display panel to operate in a blanking stage. Magnitude of the electrical signal generated by the electrical signal generation module during the blanking stage is smaller than magnitude of the electrical signal generated during the scanning stage.

In another embodiment of the present disclosure, the scanning stage comprises a plurality of row scanning stages, and the blanking stage comprises a plurality of row blanking stages and a plurality of frame blanking stages. In one frame, there is a row blanking stage disposed between an adjacent two row scanning stages, and there is a frame blanking stage disposed between two scanning stages corresponding to an adjacent two frames. The display driving system further comprises a timing controller, configured to generate a plurality of row blanking flags during the row blanking stage and a plurality of frame blanking flags during the frame blanking stage. The instruction comprises a row blanking flag and a frame blanking flag.

In another embodiment of the present disclosure, the frame blanking flag comprises a first frame blanking flag and a second frame blanking flag located after the first frame blanking flag. The source driver further comprises a timer, electrically connected between the recognition module and the power saving control module, configured to obtain an interval disposed between the first frame blanking flag and the second frame blanking flag, in order to determine the frame blanking stage and control the power saving control module to generate the corresponding power saving control signal.

In another embodiment of the present disclosure, the blanking flag comprises a first blanking flag and a third blanking flag located after the first blanking flag. The power saving control module is configured to generate corresponding power saving control signals based on the first blanking flag and the third blanking flag.

The present disclosure also provides a display device comprising a display driving system and a display panel. The display driving system includes a source driver and a power managing circuit. The source driver includes a recognition module configured to recognize an instruction, and a power saving control module, electrically connected to the recognition module for generating a plurality of power saving control signals based on the instruction. The power managing circuit is electrically connected to the source driver. The power managing circuit includes an electrical signal generation module, electrically connected to the power saving control module for reducing a magnitude of the generated electrical signal based on the power saving control signal.

In one embodiment of the present disclosure, the power saving control module comprises a plurality of switch elements connected in parallel. A plurality of input terminals of the plurality of switch elements are electrically connected and loaded with working voltage, and a plurality of output terminals of the plurality of switch elements are connected to the electrical signal generation module. The source driver further comprises a logic module, electrically connected to a plurality of control terminals of the recognition module and the switching elements, configured to turn on and turn off the plurality of switching elements according to the instruction, in order to control the power saving control module to generate the power saving control signal.

In another embodiment of the present disclosure, the display driving system is configured to control the display panel to operate in a scanning stage and to control the display panel to operate in a blanking stage. Magnitude of the electrical signal generated by the electrical signal generation module during the blanking stage is smaller than magnitude of the electrical signal generated during the scanning stage.

In another embodiment of the present disclosure, the scanning stage comprises a plurality of row scanning stages, and the blanking stage comprises a plurality of row blanking stages and a plurality of frame blanking stages. In one frame, there is a row blanking stage disposed between an adjacent two row scanning stages, and there is a frame blanking stage disposed between two scanning stages corresponding to an adjacent two frames. The display driving system further comprises a timing controller, configured to generate a plurality of row blanking flags during the row blanking stage and a plurality of frame blanking flags during the frame blanking stage. The instruction comprises a row blanking flag and a frame blanking flag.

In another embodiment of the present disclosure, the frame blanking flag comprises a first frame blanking flag and a second frame blanking flag located after the first frame blanking flag. The source driver further comprises a timer, electrically connected between the recognition module and the power saving control module, configured to obtain an interval disposed between the first frame blanking flag and the second frame blanking flag, in order to determine the frame blanking stage and control the power saving control module to generate the corresponding power saving control signal.

In another embodiment of the present disclosure, the blanking flag comprises a first blanking flag and a third blanking flag located after the first blanking flag. The power saving control module is configured to generate corresponding power saving control signals based on the first blanking flag and the third blanking flag.

The present disclosure also provides a driving method for a display driving system applied to a display panel. The method includes obtaining a first instruction and determine whether the first instruction comprises a first flag; in response to the first instruction comprising the first flag, a power saving control signal is generated based on the first flag, and a magnitude of the generated electrical signal is reduced based on the power saving control signal to control the display panel to enter power saving mode.

In another embodiment of the present disclosure, the step of reducing the magnitude of the generated electrical signal based on the power saving control signal to control the display panel to enter power saving mode comprise starting a first timing. After reducing the magnitude of the generated electrical signal based on the power saving control signal to control the display panel to enter power saving mode, the step comprise: obtaining a second instruction and determine whether the second instruction comprises a second flag; in response to the instruction comprising the second flag, obtaining a first timing value of the first timing and start the second timing after clearing to zero; obtaining a second timing value for the second timing and determine whether the second timing value and the first timing value meet the preset relationship; in response to the second timing value and the first timing value meeting the preset relationship, controlling the display panel to exit the power saving mode.

In another embodiment of the present disclosure, the step of reducing the magnitude of the generated electrical signal based on the power saving control signal to control the display panel to enter power saving mode comprises: obtaining the second instruction and determine whether the instruction comprises a third flag; in response to the second instruction comprising the third flag, controlling the display panel to exit the power saving mode.

The present disclosure provides a display driving system and its driving method, as well as a display device. The display driving system includes a source driver and a power managing circuit. The source driver includes a recognition module configured to recognize an instruction, and a power saving control module, electrically connected to the recognition module for generating a plurality of power saving control signals based on the instruction. The power managing circuit is electrically connected to the source driver. The power managing circuit includes an electrical signal generation module, electrically connected to the power saving control module for reducing a magnitude of the generated electrical signal based on the power saving control signal. The power saving control module can generate power saving control signals under the instruction corresponding to the working state with low power consumption requirements, and the electrical signal generation module used to generate electrical signals can reduce the magnitude of the generated electrical signals based on the power saving control signal, thereby achieving the goal of saving power consumption.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 illustrates a block diagram of a display driving system according to one embodiment of the present disclosure.

FIG. 2 is a circuit diagram of some modules of the display driving system according to one embodiment of the present disclosure.

FIG. 3 illustrates a block diagram of a display driving system according to another embodiment of the present disclosure.

FIGS. 4, 5 and 6 are flowcharts of a method of driving the display driving system according to one embodiment of the present disclosure.

FIG. 7 illustrates waveforms of partial signals applied on the display driving system according to one embodiment of the present disclosure.

FIG. 8 is a flowchart of a method of driving the display driving system according to another embodiment of the present disclosure.

FIG. 9 is a block diagram of a display device according to one embodiment of the present disclosure.

### DESCRIPTION OF THE EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

The term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features. In the description of the present disclosure, the meaning of “plural” is two or more, unless otherwise specifically defined.

The term “embodiment” means that a particular feature, structure or characteristic described in connection with the embodiment can be included in at least one embodiment of the invention. The appearances of this phrase at various places in the specification are not necessarily all referring to the same embodiment, nor are separate or alternative embodiments mutually exclusive of other embodiments. Those skilled in the art understand, both explicitly and implicitly, that the embodiments described herein may be combined with other embodiments.

The present invention provides a display driving system applied to a display panel and a display device including the display driving system. The display driving system may include but is not limited to the following embodiments and combinations of the following embodiments.

As shown in FIG. 9, the display device 1000 comprises a display panel 200 and a display driving system 100 electrically connected to the display panel 200. The display driving system 100 comprises a timing controller 50, a gate driver 700 electrically connected to the timing controller 50, a source driver 60, and a power managing circuit 80 for supplying power to the timing controller 50, gate driver 700, and source driver 60. The display panel 200 can comprise a plurality of sub-pixels 101. Taking the arrangement of a plurality of sub-pixel arrays into n rows and m columns as an example, the gate driver 700 can receive the first control signal generated by the timing controller 50 and generate n gate signals (GL1 to GLn) based on it. Gate signals GL1 to GLn are corresponding loaded onto n rows of sub-pixels 101 to turn on n rows of sub-pixels 101 sequentially, the source driver 60 can receive the second control signal generated by the timing controller 50 and generate m data signals (DL1 to DLm) based on it. Sata signals DL1 to DLm are loaded onto m sub-pixels 101 located in the same row that is currently in the open state to control the emission of all m sub-pixels 101 in that row. In this way, n rows of sub-pixels 101 emit light sequentially to present a frame of image.

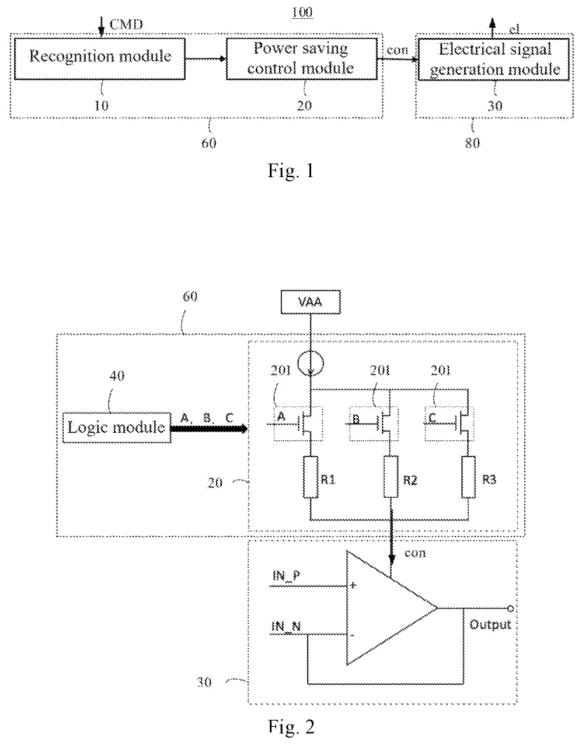

As shown in FIGS. 1 and 9, the display driving system 100 comprises at least one source driver 60, a power managing circuit 80 electrically connected to the source driver 60, and the source driver 60 comprises a recognition module 10 for identifying instruction CMD, and a power saving control module 20 electrically connected to the recognition module 10 for generating a power saving control signal con based on the instruction CMD. The power managing circuit 80 comprises an electrical signal generation module 30 for generating an electrical signal el, which is electrically connected to the power saving control module 20 for reducing the magnitude of the generated electrical signal el based on the power saving control signal con. This embodiment does not limit the transmission protocol of the display driving system 100, only the above functions are required. The display driving system 100 can drive a plurality of sub-pixels for screen display. For ease of description, the following text will explain the arrangement of a plurality of sub-pixels along the row and column directions. However, the present disclosure is not limited to this arrangement, and the setting methods corresponding to other arrangement methods can also be adjusted according to this design concept.

The above instruction can comprise the content shown in Table 1, where “Line 1”, “Line 2” . . . “Last Line data” corresponds to the first row of sub-pixels, the second row of sub-pixels, and the last row of sub-pixels, respectively. CT can be the handshake flag used to control the handshake between the sender and receiver, confirm that data communication is about to occur, CS can be the start flag of data transmission, CE can be the end flag of data transmission, “RGB data” can be the grayscale information of the sub-pixels in the row, used to control the luminescence of the sub-pixels in the row. CMD1 can be an odd row flag, indicating that the corresponding “RGB data” corresponds to odd row sub-pixels, CMD2 can be an even row flag, indicating that the corresponding “RGB data” corresponds to even row sub-pixels, CMD3 can be a frame check flag, and “Frame CTL setting” can be the data required for frame check, CMD4 can be the first frame blanking flag, and CMD5 can be the second frame blanking flag.

TABLE 1

| | | | | | |
|---|---|---|---|---|---|
| Line1 | CT | CS | CMD1 | RGB data | CE |
| Line2 | CT | CS | CMD2 | RGB data | CE |
| . | CT | CS | CMD1 | RGB data | CE |
| . | CT | CS | CMD2 | RGB data | CE |
| . | CT | CS | CMD1 | RGB data | CE |
| | CT | CS | CMD2 | RGB data | CE |
| | CT | CS | CMD1 | RGB data | CE |
| Last Line data | CT | CS | CMD2 | RGB data | CE |
| Setting | CT | CS | CMD3 | Frame CTL setting | CE |

| | | | | |
|---|---|---|---|---|
| Vertical | CT | CS | CMD4 | CT |
| blanking | CT | CS | CMD5 | CT |

In this embodiment, there is a recognition module 10 that can be used to recognize instruction CMD. As discussed, the current instruction CMD can represent a current working state of the display driving system 100, and it can be considered that different working states have different power consumption requirements. Furthermore, the power saving control module 20 in this embodiment can be used to generate a power saving control signal con based on the instruction CMD (i.e., according to the working state), that is, to generate a power saving control signal con under the instruction CMD corresponding to the working state with lower power consumption requirements. This can be applied to the electrical signal generation module 30 for generating the electrical signal el, and can be used to reduce the magnitude of the generated electrical signal el based on the power saving control signal con, so as to save power consumption.

As shown in FIGS. 1 and 2, the power saving control module 20 comprises a plurality of switch elements 201 connected in parallel. Input terminals of the plurality of switch elements 201 are electrically connected to receive the working voltage VAA. Output terminals of the plurality of switch elements 201 are connected to the electrical signal generation module. The source driver 60 further comprises a logic module 40 electrically connected between the recognition module 10 and control terminals of the plurality of switching elements 201, for controlling the opening and closing of the switching elements 201 according to the instruction, to control the power saving control module 20 to generate the power saving control signal con. In this embodiment, there is no limitation on the amplitude of the working voltage VAA. In order to reduce the risk of burning out the switching element 201 due to the large flowing current of each switching element 201, a resistor element (R1, R2, R3) that is connected in series with the switching element 201 can also be set along the path of each switching element 201. For ease of description, the switching element 201 is a transistor, and the power saving control module 20 comprises three switch elements 201 connected in parallel, but the present disclosure is not limited to this device type and number. The setting methods corresponding to other device types and numbers can also be adjusted according to this design concept.

According to the above settings, the logic module 40 can comprise three output terminals electrically connected to the gates of three transistors (i.e. the control terminal of switch element 201) to load the first voltage A, second voltage B, and third voltage C respectively. The three transistors can be turned on or off based on the magnitude of the first voltage A, second voltage B, and third voltage C generated by logic module 40. The sources of the three transistors are all loaded with the aforementioned working voltage VAA. The power saving control signal con can be understood as a sum of the current signals output by the drains of three transistors, or as the voltage signal synthesized by the drains of three transistors. It can be understood that more transistors are turned on, the more number the branch circuits generating current is, and the greater the sum of the current signals output by the drains of the three transistors is. It can also be understood that there are more branch circuits are connected in parallel, and the overall resistance value is smaller. Therefore, the smaller the voltage drop generated by the working voltage VAA is, the greater the voltage of the drains of the three transistors is. It can be assumed that the greater the magnitude of the power saving control signal con generated by the power saving control module 20 is, the smaller or larger the magnitude of the electrical signal el generated by the electrical signal generation module 30. On the contrary, the fewer transistors turned on, the larger or smaller the magnitude of the generated electrical signal el.

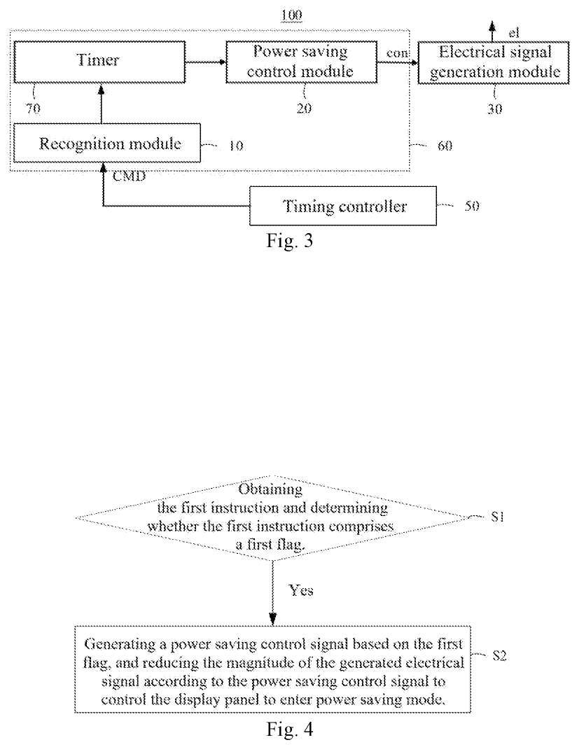

In this embodiment, there is no limitation on the specific circuit structure of the electrical signal generation module 30, which can be understood as being controlled by the power saving control signal con to process the input signal to generate the corresponding electrical signal el. As shown in FIG. 3, the electrical signal generation module 30 in this embodiment may comprise but is not limited to an operational amplifier circuit, which may comprise a forward input terminal IN_P. Reverse input terminal IN_N. The control terminal used to load the power saving control signal con and the output terminal used to output the electrical signal el. Among them, the output voltage of the operational amplifier circuit can be determined by the forward input terminal IN_ Voltage of P, reverse input terminal IN_ The voltage of N jointly determines the output current of the operational amplifier circuit, which can be determined by the power saving control signal con. This ensures that the voltage of the output of the operational amplifier circuit is maintained at a certain level (i.e., the transmission of the original voltage value is maintained), and the power saving control signal con is used to reduce the current of the output of the operational amplifier circuit, thereby reducing power consumption.

In this embodiment, there is no limitation on the specific module connected to the output of the operational amplifier circuit. It can be understood that the output of the operational amplifier circuit transmits a voltage signal to the corresponding module (independent of power consumption requirements), and can also transmit a current signal of the corresponding size according to the power consumption requirements of the corresponding module. Specifically, logic module 40 can control the signals acting on power saving control module 20 based on instruction (including but not limited to the first voltage A, second voltage B, and third voltage C), and then control the specific value of the power saving control signal con generated by power saving control module 20 to reduce the corresponding amplitude of the electrical signal el (which can be understood as the current value) generated by electrical signal generation module 30, For example, the current value can decrease to the original 70% or other proportions.

The display driving system 100 is configured to control the display panel 200 to be in the scanning stage and to control the display panel 200 to be in the blanking stage. The magnitude of the electrical signal el generated by the electrical signal generation module 30 during the blanking stage is smaller than the magnitude of the electrical signal el generated during the scanning stage. Based on Table 1 and related discussions, it can be seen that different working states have different power consumption requirements. The scanning stage here can be understood as the stage where each row of sub-pixels is turned on and a plurality of sub-pixels in that row are loaded with corresponding data signals (generated based on the corresponding “RGB data”). Since this stage requires turning on sub-pixels and loading corresponding data voltages to them, Therefore, the scanning stage (at least corresponding to the time period for transmitting each “Line” content in Table 1) can be considered as a stage with a high demand for power consumption. Correspondingly, the other stages can be called the blanking stage. At this time, since the sub-pixels have already been loaded with the corresponding data voltage, they only need to maintain the corresponding brightness, Therefore, the blanking stage (at least corresponding to the frame blanking period in Table 1, i.e. “Vertical Blanking”) can be considered as a stage with lower power consumption requirements.

In summary, in this embodiment, by setting the recognition module 10, power saving control module 20, and electrical signal generation module 30 in the display driving system 100, the recognition module 10 can be set to recognize instruction corresponding to the blanking stage, so that the power saving control module 20 generates a power saving control signal con during the blanking stage, and further controls the electrical signal generation module 30 to reduce the magnitude of the generated electrical signal el through the power saving control signal con, So as to achieve the effect of saving power consumption.

Furthermore, in combination with Table 1, the scanning stage comprises a plurality of row scanning stages, and the blanking stage comprises a plurality of row blanking stages and frame blanking stages. In one frame, there is a row blanking stage between the adjacent two row scanning stages, and a frame blanking stage between the two scanning stages corresponding to the adjacent two frames. Specifically, the time period for transmitting the “Line” content corresponding to each row of sub-pixels can be referred to as the row scanning period, and a time gap can be considered between the time periods for transmitting the “Line” content corresponding to adjacent two rows of sub-pixels. This time gap can be referred to as the row blanking stage, and after the scanning period corresponding to the last row of sub-pixels, it can be considered as the frame blanking stage, Until the scanning period corresponding to the first row of sub-pixels in the next frame is opened.

As shown in FIGS. 1, 2, and 3, the display driving system 100 comprises a timing controller 50 for generating a row blanking flag (which can be included in the entire instruction CMD) during the row blanking stage, and generating a frame blanking flag (which can be comprised in the entire instruction CMD) during the frame blanking stage. The source driver 60 comprises the recognition module 10 and the power saving control module 20, and the instruction CMD comprises at least one of the row blanking flag and the frame blanking flag.

Based on the previous discussion on Table 1, for example, if the electrical signal generation module 30 is used to control the decrease of the magnitude of the electrical signal el during the frame blanking stage, it can be considered that the recognition module 10 is used to generate the power saving control signal con during the recognition of the frame blanking flag (including at least one of the first frame blanking flag CMD4 and the second frame blanking flag CMD5). For example, if the electrical signal generation module 30 is used to control the decrease of the magnitude of the electrical signal el during the row blanking stage, it can be considered that the power saving control module 20 is used to generate the power saving control signal con during the recognition of the row blanking flag (which can be located before the end flag CE of the data transmission corresponding to the previous line sub-pixel and the handshake flag CT corresponding to the next line sub-pixel, and of course, it can also comprise the end flag CE of the corresponding data transmission).

In one embodiment, as shown in Table 1, the frame blanking flag comprises a first frame blanking flag (such as the first frame blanking flag CMD4) and a second frame blanking flag (such as the second frame blanking flag CMD5) located after the first frame blanking flag. The source driver 60 further comprises a timer 70 electrically connected between the recognition module 10 and the power saving control module 20, for obtaining the interval between the first frame blanking flag and the second frame blanking flag, to determine the frame blanking stage, and to control the power saving control module 20 to generate the corresponding power saving control signal con.

According to Table 1, it can be seen that the first frame of the blanking flag (such as the first frame blanking flag CMD4) can be transmitted first to indicate entering the frame blanking stage, and then the handshake flag CT corresponding to it, the handshake flag CT corresponding to it before the second frame blanking flag (such as the second frame blanking flag CMD5), and the start flag CS of data transmission can be sequentially transmitted. Then, the second frame blanking flag (such as the second frame blanking flag CMD5) can be transmitted, which means that the interval between the first frame blanking flag and the second frame blanking flag is equal to the duration of transmitting two handshake flags CT and one start flag CS of data transmission. Similarly, by observing Table 1, it can be seen that the interval between the second frame blanking flag CMD5 and the odd row flag CMD1 corresponding to the first row of sub-pixels in the next frame is also equal to the above duration, and a new round of scanning stage is entered after the odd row flag CMD1. Therefore, obtaining the interval between the first frame blanking flag and the second frame blanking flag can determine the end time of the frame blanking stage (i.e. the time when the odd row flag CMD1 corresponding to the first row of sub-pixels in the next frame is recognized), thereby determining the hidden period to ensure that the power saving control signal con can be maintained during this period and achieve low power consumption during this period.

As shown in Table 1, the blanking flag comprises a first blanking flag (such as the first frame blanking flag CMD4) and a third blanking flag located after the first blanking flag (such as the odd row flag CMD1 corresponding to the first row sub-pixel of the next frame). The power saving control module 20 is used to generate the corresponding power saving control signal con based on the first blanking flag and the third blanking flag.

The recognition module 10 can determine the end time of the frame blanking stage by recognizing the third blanking flag, without setting the timer 70 to further determine the end time of the frame blanking stage based on the recognition module 10's recognition of the second frame blanking flag.

The present disclosure also provides a driving method for a display driving system applied to a display panel, as shown in FIG. 4, which may comprise the following steps.
S1, obtaining the first instruction and determining whether the first instruction comprises a first flag.

The first instruction here can be understood as, for example, the recognition module 10 continuously obtains the flag and determines whether the flag obtained each time is the first flag. Step S1 can be considered that the display panel has not entered the power saving mode, that is, it can be considered that the magnitude of the electrical signal el generated by the electrical signal generation module 30 is still relatively large. The instruction including a plurality of flags obtained for judgment at this stage is called the first instruction.

When the first instruction comprises the first flag, the method performs:
S2, generating a power saving control signal based on the first flag, and reducing the magnitude of the generated electrical signal according to the power saving control signal to control the display panel to enter power saving mode.

The first flag can be the first frame blanking flag (such as the first frame blanking flag CMD4), which can indicate that the display panel has just completed all scanning stages of a frame, entered the frame blanking stage, and entered the power saving mode. At this stage, as discussed earlier, for example, the power saving control module 20 can generate a power saving control signal con, and the electrical signal generation module 30 can reduce the magnitude of the generated electrical signal el based on the power saving control signal con, The specific reduction principle can refer to the discussion on FIG. 2 in the previous text.

If the first instruction does not comprise the first flag, step S1 can be continued to obtain and determine the first instruction.

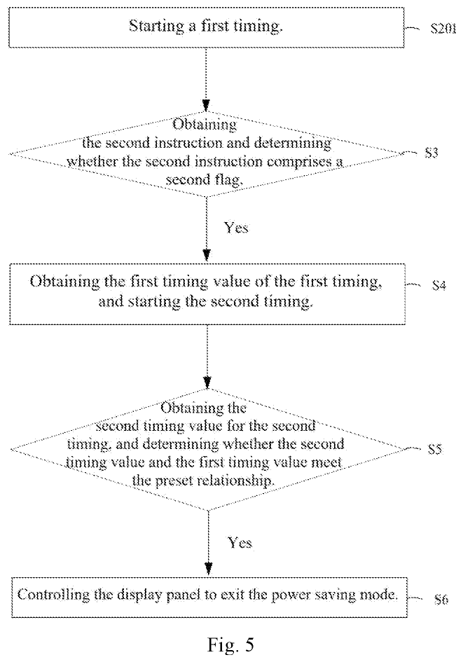

As shown in FIG. 5, step S2 comprises step S201 which is step of starting a first timing.

Furthermore, after step S2, it may comprise steps S3 to step S6.
In S3, obtaining the second instruction and determining whether the second instruction comprises a second flag.

Similarly, the second instruction can be understood as, for example, the recognition module 10 continuously obtains the flag after recognizing the first flag, and determines whether each acquired flag is the second flag. Step S3 can be considered that the display panel is in power saving mode, that is, it can be considered that the magnitude of the electrical signal el generated by the electrical signal generation module 30 can be controlled by the power saving control signal con and reduced.

If the instruction comprises the second flag, the method performs:
S4, obtaining the first timing value of the first timing, and starting the second timing.

The second flag can be, but is not limited to, the second frame blanking flag mentioned earlier (such as the second frame blanking flag CMD5). Based on the previous discussion, at this time, after the transmission of the first frame blanking flag (such as the first frame blanking flag CMD4), two handshake flags CT and one start flag CS for data transmission have been completed. Therefore, the first timing value obtained at this time is equal to the duration of transmitting two handshake flags CT and one start flag CS for data transmission. Based on the previous discussion, if two more handshake flags CT and one start flag CS for data transmission are transmitted, it can be considered to enter a new round of scanning phase.
S5, obtaining the second timing value for the second timing, and determining whether the second timing value and the first timing value meet the preset relationship.

The starting time of the second timing value is the same as the ending time of the first timing value. If entering a new scanning phase, it can be determined based on whether the second timing value is equal to the first timing value (i.e. the preset relationship). Of course, depending on different transmission protocols, there may be other ways to set the preset relationship.

If the second timing value and the first timing value meet the preset relationship, then the method performs:
S6, controlling the display panel to exit the power saving mode.

When the second timing value and the first timing value meet the preset relationship, that is, entering a new round of scanning stage, that is, the current frame blanking period ends, the power saving mode can be exited. Specifically, it can be understood that the power saving control module stops outputting the power saving control signal con, so that the electrical signal generation module 30 can restore to generating an electrical signal el with the original size (larger value), instead of generating a smaller value of an electrical signal el, to perform the scanning function of the display panel.

Of course, timing can also be continued based on the first timing value to obtain the corresponding third timing value, or another preset relationship can be set to exit the power saving mode when the third timing value and the first timing value meet this preset relationship.

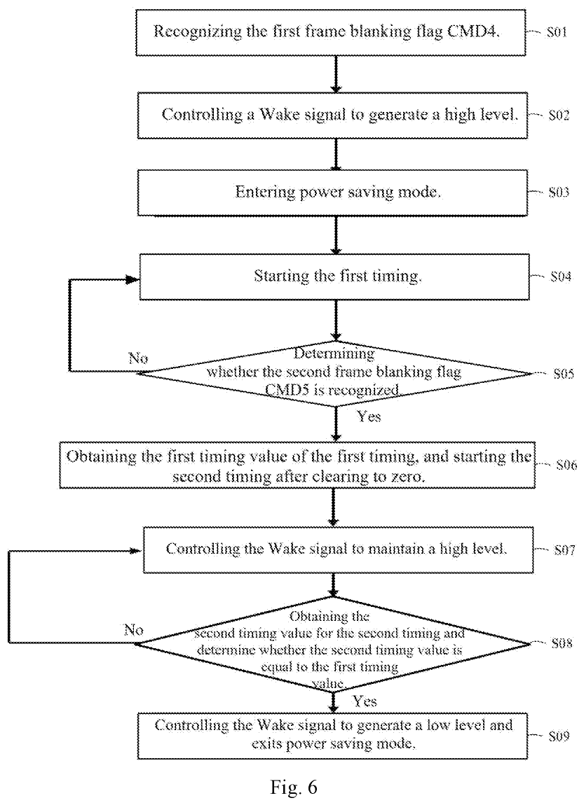

Furthermore, the methods shown in FIGS. 4 and 5 can also refer to the flowchart shown in FIG. 6, which can comprise the following steps S01-S06.

In step S01, recognizing the first frame blanking flag CMD4.

In step S02, controlling a Wake signal to generate a high level.

In step S03, entering power saving mode.

In step S04, starting the first timing.

In step S05, determining whether the second frame blanking flag CMD5 is recognized.

If the second frame blanking flag CMD5 is recognized, the method performs steps S06-S08. In step S06, obtain the first timing value of the first timing, and start the second timing after clearing to zero. In step S07, control the Wake signal to maintain a high level. In step S08, obtain the second timing value for the second timing and determine whether the second timing value is equal to the first timing value.

If the second timing value is equal to the first timing value, the method performs step S09. In step S09, control the Wake signal to generate a low level and exits power saving mode.

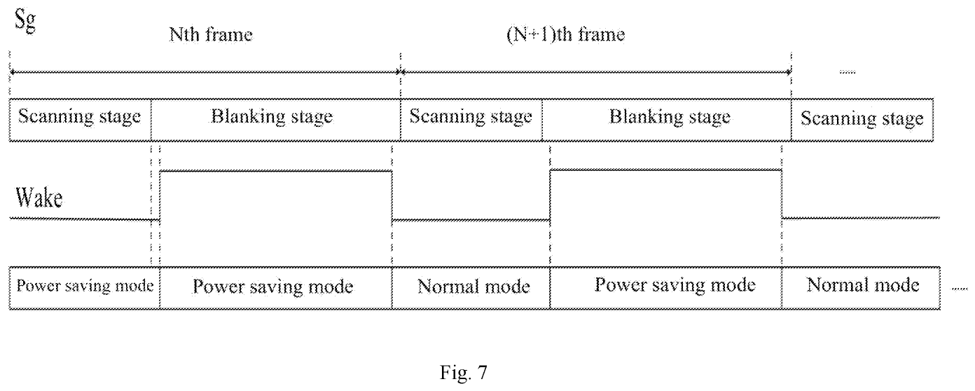

As shown in FIG. 7, the image signal Sg generated by the timing controller 50 can be divided into the Nth frame and the (N+1)th frame according to time, and the time period of each frame can be divided into corresponding scanning stage and corresponding frame blanking stage.

The Wake signal can be generated by logic module 40 based on the instruction situation in the image signal Sg. As shown in Table 1, since the first frame blanking flag CMD4 is located near the beginning of the V-BK stage, the transition of the Wake signal from low to high lags behind V-BK. Similarly, since the second frame blanking flag CMD5 is located before the Active of the next frame, the transition of the Wake signal from high to low is earlier than Active.

The Wake signal can be understood as for users to view and understand the current working stage of the display driving system 100. The logic module can also transmit a Wake signal to the power saving control module 20 to trigger entry into power saving mode through the rising edge of the Wake signal, and exit power saving mode through the falling edge of the Wake signal, i.e. entering normal mode.

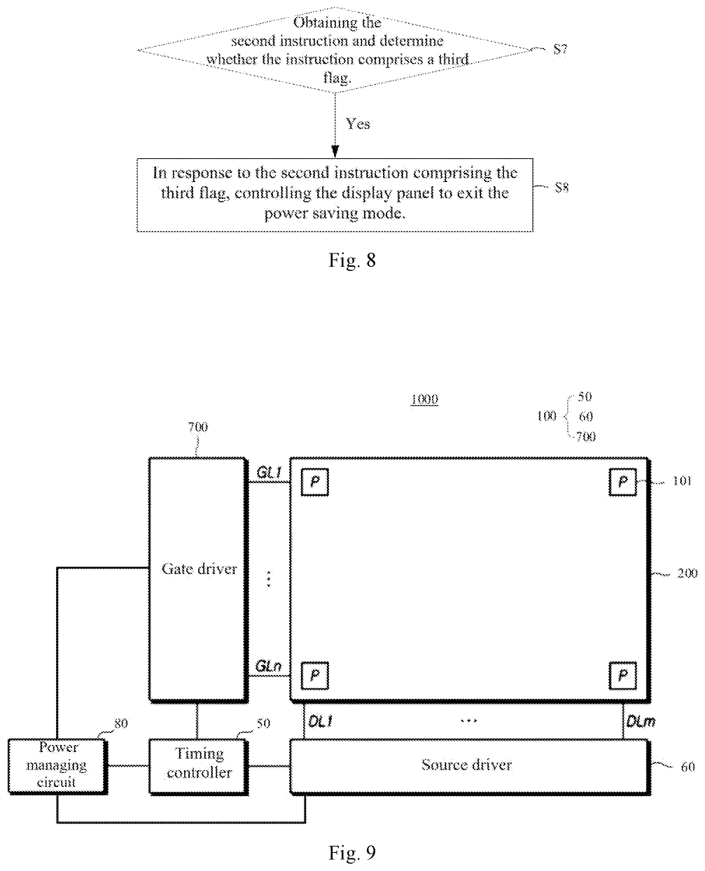

In one embodiment, after step S2, as shown in FIG. 8, it may comprise steps S7 and S8.
S7, obtaining the second instruction and determine whether the instruction comprises a third flag.

Similarly, the second instruction here can be understood as, for example, the recognition module 10 continuously obtains the flag after recognizing the first flag, and determines whether each acquired flag is a third flag. Step S7 can be considered that the display panel is in power saving mode, that is, it can be considered that the magnitude of the electrical signal el generated by the electrical signal generation module 30 can be controlled by the power saving control signal con and reduced.
S8, in response to the second instruction comprising the third flag, controlling the display panel to exit the power saving mode.

The third flag can be, but is not limited to, the second frame blanking flag mentioned above (such as the second frame blanking flag CMD5), which can indicate that the display panel is about to end the frame blanking stage of one frame and start the scanning stage of the next frame, that is, the power consumption demand is about to increase, so it can exit the power saving mode. The specific operation of exiting the power saving mode can refer to the description in step S6 above.

In other embodiments, the first flag and the corresponding second flag, or in other words, the first flag and the corresponding third flag, can also be understood as representing the starting and ending times of row blanking, that is, the above-mentioned power saving mode can also occur during the row blanking stage.

The present disclosure provides a display driving system and its driving method, as well as a display device. The display driving system includes a source driver and a power managing circuit. The source driver includes a recognition module configured to recognize an instruction, and a power saving control module, electrically connected to the recognition module for generating a plurality of power saving control signals based on the instruction. The power managing circuit is electrically connected to the source driver. The power managing circuit includes an electrical signal generation module, electrically connected to the power saving control module for reducing a magnitude of the generated electrical signal based on the power saving control signal. The power saving control module can generate power saving control signals under the instruction corresponding to the working state with low power consumption requirements, and the electrical signal generation module used to generate electrical signals can reduce the magnitude of the generated electrical signals based on the power saving control signal, thereby achieving the goal of saving power consumption.

The above is a display device provided by an embodiment of the present disclosure is described in detail, and a specific example is applied herein to explain the principle and embodiment of the present disclosure, and the description of the above embodiment is only used to help understand the method of the present disclosure and its core ideas. At the same time, for those skilled in the art, according to the idea of the present disclosure, there will be changes in the specific embodiment and the scope of application, in summary, the content of this specification should not be understood as a restriction on the present disclosure.

1. A display driving system, applied to a display panel, comprising:
a source driver, comprising:
a recognition module, configured to recognize an instruction;
a power saving control module, electrically connected to the recognition module for generating a plurality of power saving control signals based on the instruction;
a power managing circuit, electrically connected to the source driver, comprising:
an electrical signal generation module, electrically connected to the power saving control module for reducing a magnitude of the generated electrical signal based on the power saving control signal.

2. The display driving system as claimed in claim 1, wherein the power saving control module comprises a plurality of switch elements connected in parallel, a plurality of input terminals of the plurality of switch elements electrically connected and loaded with working voltage, and a plurality of output terminals of the plurality of switch elements connected to the electrical signal generation module;
wherein the source driver further comprises:
a logic module, electrically connected to a plurality of control terminals of the recognition module and the switching elements, configured to turn on and turn off the plurality of switching elements according to the instruction, in order to control the power saving control module to generate the power saving control signal.

3. The display driving system as claimed in claim 1, wherein the display driving system is configured to:
control the display panel to operate in a scanning stage;
control the display panel to operate in a blanking stage;
wherein magnitude of the electrical signal generated by the electrical signal generation module during the blanking stage is smaller than magnitude of the electrical signal generated during the scanning stage.

4. The display driving system as claimed in claim 3, wherein the scanning stage comprises a plurality of row scanning stages, and the blanking stage comprises a plurality of row blanking stages and a plurality of frame blanking stages;
in one frame, there is a row blanking stage disposed between an adjacent two row scanning stages, and there is a frame blanking stage disposed between two scanning stages corresponding to an adjacent two frames;
wherein the display driving system further comprises:
a timing controller, configured to generate a plurality of row blanking flags during the row blanking stage and a plurality of frame blanking flags during the frame blanking stage;
wherein the instruction comprises a row blanking flag and a frame blanking flag.

5. The display driving system as claimed in claim 4, wherein the frame blanking flag comprises a first frame blanking flag and a second frame blanking flag located after the first frame blanking flag;
the source driver further comprises:
a timer, electrically connected between the recognition module and the power saving control module, configured to obtain an interval disposed between the first frame blanking flag and the second frame blanking flag, in order to determine the frame blanking stage and control the power saving control module to generate the corresponding power saving control signal.

6. The display driving system as claimed in claim 4, wherein the blanking flag comprises a first blanking flag and a third blanking flag located after the first blanking flag;
the power saving control module is configured to generate corresponding power saving control signals based on the first blanking flag and the third blanking flag.

7. A display device, comprising:
a display panel; and
a display driving system, comprising:
a source driver, comprising:
a recognition module, configured to recognize an instruction, wherein the instruction is configured to indicate a current working state of the display driving system;
a power saving control module, electrically connected to the recognition module for generating a power saving control signal based on the instruction;
a power managing circuit, electrically connected to the source driver, comprising:
an electrical signal generation module, electrically connected to the power saving control module for generating an electrical signal and reducing a magnitude of the generated electrical signal based on the power saving control signal.

8. The display device as claimed in claim 7, wherein the power saving control module comprises a plurality of switch elements connected in parallel, a plurality of input terminals of the plurality of switch elements electrically connected and loaded with working voltage, and a plurality of output terminals of the plurality of switch elements connected to the electrical signal generation module;
wherein the source driver further comprises:
a logic module, electrically connected to a plurality of control terminals of the recognition module and the switching elements, configured to turn on and turn off the plurality of switching elements according to the instruction, in order to control the power saving control module to generate the power saving control signal.

9. The display device as claimed in claim 7, wherein the display driving system is configured to:
control the display panel to operate in a scanning stage;
control the display panel to operate in a blanking stage;
wherein magnitude of the electrical signal generated by the electrical signal generation module during the blanking stage is smaller than magnitude of the electrical signal generated during the scanning stage.

10. The display device as claimed in claim 9, wherein the scanning stage comprises a plurality of row scanning stages, and the blanking stage comprises a plurality of row blanking stages and a plurality of frame blanking stages;
in one frame, there is a row blanking stage disposed between two adjacent ones of the plurality of row blanking stages, and there is a frame blanking stage disposed between two scanning stages corresponding to two adjacent ones of a plurality of frames;
wherein the display driving system further comprises:
a timing controller, configured to generate a plurality of row blanking flags during the row blanking stage and a plurality of frame blanking flags during the frame blanking stage;
wherein the instruction comprises a row blanking flag and a frame blanking flag.

11. The display device as claimed in claim 10, wherein the frame blanking flag comprises a first frame blanking flag and a second frame blanking flag located after the first frame blanking flag;
the source driver further comprises:
a timer, electrically connected between the recognition module and the power saving control module, configured to obtain an interval disposed between the first frame blanking flag and the second frame blanking flag, in order to determine the frame blanking stage and control the power saving control module to generate the corresponding power saving control signal.

12. The display device as claimed in claim 10, wherein the frame blanking flag comprises a first blanking flag and a third blanking flag located after the first blanking flag;
the power saving control module is configured to generate corresponding power saving control signals based on the first blanking flag and the third blanking flag.

13. A driving method for a display driving system applied to a display panel, comprising:
obtaining a first instruction and determine whether the first instruction comprises a first flag;
in response to the first instruction comprising the first flag, a power saving control signal is generated based on the first flag, and a magnitude of the generated electrical signal is reduced based on the power saving control signal to control the display panel to enter power saving mode.

14. The method as claimed in claim 13, wherein the step of reducing the magnitude of the generated electrical signal based on the power saving control signal to control the display panel to enter power saving mode comprise:
starting a first timing;
after reducing the magnitude of the generated electrical signal based on the power saving control signal to control the display panel to enter power saving mode, the step comprises:
obtaining a second instruction and determine whether the second instruction comprises a second flag;
in response to the instruction comprising the second flag, obtaining a first timing value of the first timing and start the second timing after clearing to zero;
obtaining a second timing value for the second timing and determine whether the second timing value and the first timing value meet the preset relationship;
in response to the second timing value and the first timing value meeting the preset relationship, controlling the display panel to exit the power saving mode.

15. The method as claimed in claim 14, wherein the step of reducing the magnitude of the generated electrical signal based on the power saving control signal to control the display panel to enter power saving mode comprises:
obtaining the second instruction and determine whether the instruction comprises a third flag;
in response to the second instruction comprising the third flag, controlling the display panel to exit the power saving mode.

16. The display device as claimed in claim 12, wherein the recognition module is configured to determine end time of the frame blanking stage by recognizing the third blanking flag.
